(19) United States
(12) Patent Application Publication
(10) Pub. No.: US 2026/0008385 A1
(43) Pub. Date: Jan. 8, 2026

(54) SYSTEMS AND METHODS FOR CONTROLLING COLD STARTUP OF A FUEL CELL

(71) Applicant: Toyota Motor Engineering & Manufacturing North America, Inc., Plano, TX (US)

(72) Inventor: Arlo Conrad Eitzer, Ann Arbor, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/761,396

(22) Filed: Jul. 2, 2024

(51) Int. Cl. B60L 58/31; B60L 58/33; B60L 58/40; H01M 8/04302; H01M 8/0432

(52) U.S. Cl. CPC B60L 58/31; B60L 58/33; B60L 58/40; H01M 8/04302; H01M 8/0432; H01M 2250/20

(57) ABSTRACT

Systems and methods described herein relate to controlling cold startup of a fuel cell. In one embodiment, a system for controlling cold startup of a fuel cell detects that a fuel cell and a high-voltage battery are at a temperature below a predetermined threshold temperature below which discharging power from the high-voltage battery is permitted and charging the high-voltage battery is not permitted. The system activates a battery heater and powers the battery heater using the high-voltage battery. The system starts up the fuel cell by drawing additional power from the high-voltage battery. The system consumes, in the battery heater, power generated by the fuel cell during startup until the fuel cell is fully started up to avoid charging the high-voltage battery while charging the high-voltage battery is not permitted.

### TECHNICAL FIELD

The subject matter described herein relates in general to fuel cells and, more specifically, to systems and methods for controlling cold startup of a fuel cell.

### BACKGROUND

Fuel cells such as hydrogen-powered fuel cells are becoming increasingly popular in a variety of applications, including powering vehicles. Though fuel cells have attractive advantages such as high efficiency and low emissions, starting up a fuel cell at low temperatures presents challenges. Conventional cold-startup procedures take additional time to start up the fuel cell, which is undesirable from a user's standpoint.

### SUMMARY

An example of a system for controlling cold startup of a fuel cell is presented herein. The system comprises a processor and a memory storing machine-readable instructions that, when executed by the processor, cause the processor to detect that a fuel cell and a high-voltage battery are at a temperature below a predetermined threshold temperature below which discharging power from the high-voltage battery is permitted and charging the high-voltage battery is not permitted. The memory also stores machine-readable instructions that, when executed by the processor, cause the processor to activate a battery heater and power the battery heater using the high-voltage battery. The memory also stores machine-readable instructions that, when executed by the processor, cause the processor to start up the fuel cell by drawing additional power from the high-voltage battery. The memory also stores machine-readable instructions that, when executed by the processor, cause the processor to consume, in the battery heater, power generated by the fuel cell during startup until the fuel cell is fully started up to avoid charging the high-voltage battery while charging the high-voltage battery is not permitted.

Another embodiment is a non-transitory computer-readable medium for controlling cold startup of a fuel cell and storing instructions that, when executed by a processor, cause the processor to detect that the fuel cell and a high-voltage battery are at a temperature below a predetermined threshold temperature below which discharging power from the high-voltage battery is permitted and charging the high-voltage battery is not permitted. The instructions also cause the processor to activate a battery heater and power the battery heater using the high-voltage battery. The instructions also cause the processor to start up the fuel cell by drawing additional power from the high-voltage battery. The instructions also cause the processor to consume, in the battery heater, power generated by the fuel cell during startup until the fuel cell is fully started up to avoid charging the high-voltage battery while charging the high-voltage battery is not permitted.

Another embodiment is a method of controlling cold startup of a fuel cell, the method comprising detecting that a fuel cell and a high-voltage battery are at a temperature below a predetermined threshold temperature below which discharging power from the high-voltage battery is permitted and charging the high-voltage battery is not permitted. The method also includes activating a battery heater and powering the battery heater using the high-voltage battery. The method also includes starting up the fuel cell by drawing additional power from the high-voltage battery. The method also includes consuming, in the battery heater, power generated by the fuel cell during startup until the fuel cell is fully started up to avoid charging the high-voltage battery while charging the high-voltage battery is not permitted.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is a block diagram of an environment in which embodiments of a cold-startup control system for a fuel cell can be implemented.

FIG. 2 is a block diagram of a cold-startup control system for a fuel cell, in accordance with an illustrative embodiment of the invention.

FIG. 3 is a flowchart of a method of controlling cold startup of a fuel cell, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

As those skilled in the art are aware, the conventional startup procedure for a fuel cell (e.g., a hydrogen-powered fuel cell) is to (1) turn on a 12-V power system, (2) connect a high-voltage (HV) battery, (3) pull (discharge) power from the HV battery to “jump start” the fuel cell and raise its voltage and (4) push power to (charge) the HV battery using power generated by the fuel cell to finish starting up the fuel cell. As mentioned in the Background, challenges arise at low temperatures. More specifically, at low temperatures, the HV battery is able to discharge power, but charging the HV battery is not permitted due to the limitations of the chemistry of the HV battery. Charging the HV battery at too low of a temperature can damage the HV battery. The conventional solution to this problem is to delay starting up the fuel cell, using a battery heater to warm up the HV battery until the HV battery is warm enough to permit charging, and then starting the fuel cell. Having to warm up the HV battery before starting the fuel cell means it takes longer to start the fuel cell under cold conditions than under normal conditions. Users do not like having to wait longer for the fuel cell to start up.

Various embodiments of systems and methods for controlling cold startup of a fuel cell described herein overcome the disadvantage of conventional approaches just described by shortening the time required to start a fuel cell under low-temperature conditions. A central technique is these various embodiments is consuming, in a battery heater, power generated by the fuel cell during startup, since charging the HV battery using that initial fuel-cell-generated power is not permitted. This innovative approach is faster than waiting for a battery heater to warm the HV battery to a temperature at which the HV battery can be charged before starting the fuel cell.

In embodiments, a system for controlling cold startup of a fuel cell (1) detects that the fuel cell and the HV battery are at a temperature below a predetermined threshold temperature below which discharging power from the HV battery is permitted and charging the HV battery is not permitted; (2) activates a battery heater and powers the battery heater using the HV battery; (3) starts up the fuel cell by drawing additional power from the HV battery; and (4) consumes, in the battery heater, power generated by the fuel cell during startup until the fuel cell is fully started up to avoid charging the HV battery while charging the HV battery is not permitted. In some embodiments, once the fuel cell is fully started up, the system powers the battery heater using power generated by the fuel cell to continue warming up the HV battery.

In some embodiments, the fuel cell powers a vehicle. In other embodiments, the fuel cell powers a stationary electrical generator.

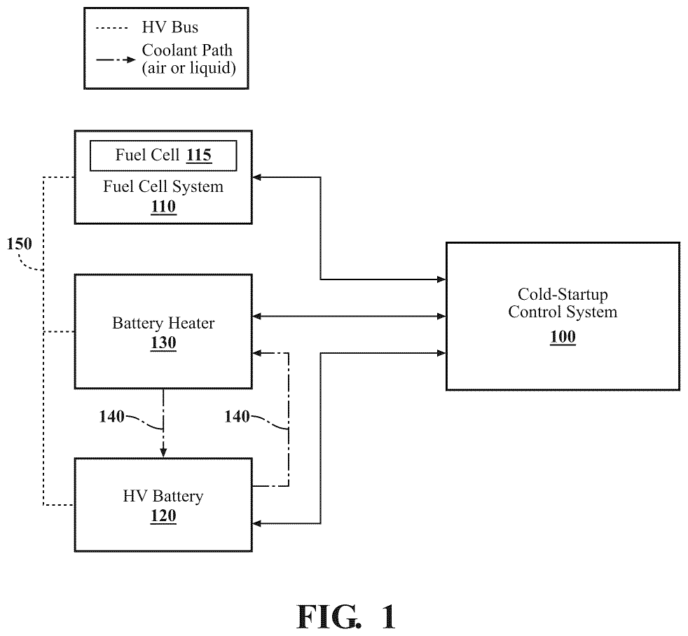

Referring to FIG. 1, it is a block diagram of an environment in which embodiments of a cold-startup control system for a fuel cell can be implemented. In the embodiment of FIG. 1, a cold-startup control system 100 communicates with a fuel cell system 110, a HV battery 120, and a battery heater 130 to control and coordinate their operation during cold startup. The fuel cell system 110 includes a fuel cell 115, which, in some embodiments, is a hydrogen-powered fuel cell. Fuel cell system 110 also includes other associated components such as one or more hydrogen storage tanks and, in some embodiments, a local controller (not shown in FIG. 1).

HV Battery 120 is, in some embodiments, a lithium battery with a voltage exceeding 48 V DC. In some embodiments, the voltage of the HV battery 120 is 400 V DC or 650 V DC. In still other embodiments, the voltage of the HV battery 120 is as high as 800 V DC. In some embodiments, HV battery 120 includes its own local controller.

Battery heater 130 is, in some embodiments, a high-voltage electric heater. In other embodiments, battery heater 130 is a low-voltage electric heater for which a DC-to-DC converter (not shown in FIG. 1) converts the high voltage of the fuel cell 115 to the lower voltage required by the battery heater 130, permitting the battery heater 130 to consume power from the fuel cell 115 during cold startup, as discussed above. In some embodiments, battery heater 130 includes its own local controller.

As shown in FIG. 1, fuel cell system 110, HV battery 120, and battery heater 130 are interconnected by a HV (high-voltage) bus 150. Some embodiments include a coolant path 140 (for air or liquid). In some embodiments, the cooling system that cools HV battery 120 serves the additional purpose of warming the HV battery 120 at low temperatures. In those embodiments, a radiator and a heat pump are used to warm up and cool down the coolant in coolant path 140 as needed. In other embodiments, the HV battery 120 is air cooled, and an ambient-air heater is used to warm the HV battery 120, when needed. Thus, the coolant path 140 shown in FIG. 1 is not present in all embodiments.

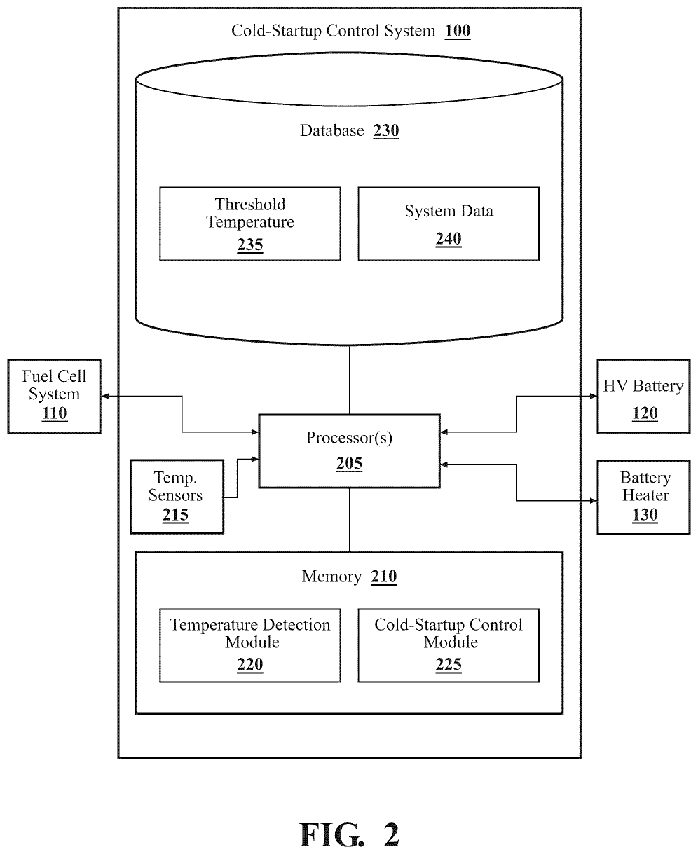

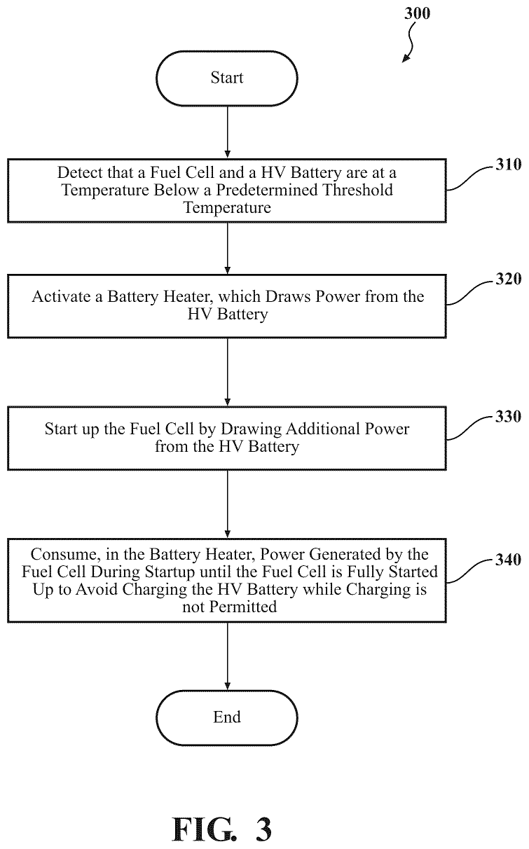

In some embodiments, the functionality of cold-startup control system 100 (explained further below in connection with FIGS. 2 and 3) can be centralized to some extent, as depicted in FIG. 1. In other embodiments, that functionality instead resides in the local controller of the fuel cell system 110, the HV battery 120, or the battery heater 130. In still other embodiments, that functionality is distributed among two or all three of the local controllers just mentioned.

In some embodiments, cold-startup control system 100 is an aspect of a vehicle's Electronic Control Unit (ECU), and the fuel cell 115 is used to power (e.g., propel) the vehicle. In other embodiments, cold-startup control system 100 is part of a stationary electrical generator.

FIG. 2 is a block diagram of a cold-startup control system 100 for a fuel cell 115, in accordance with an illustrative embodiment of the invention. As shown in In FIG. 2, cold-startup control system 100 includes one or more processors 205. Cold-startup control system 100 also includes a memory 210 communicably coupled to the one or more processors 205. The memory 210 stores a temperature detection module 220 and a cold-startup control module 225. The memory 210 is a random-access memory (RAM), read-only memory (ROM), a hard-disk drive, a flash memory, or other suitable memory for storing the modules 220 and 225. The modules 220 and 225 are, for example, computer-readable instructions that, when executed by the one or more processors 205, cause the one or more processors 205 to perform the various functions disclosed herein.

In connection with its tasks, cold-startup control system 100 can store various kinds of data in a database 230. For example, in the embodiment shown in FIG. 2, cold-startup control system 100 stores, in database 230, threshold temperature 235 and system data 240. As discussed above, threshold temperature 235 is a predetermined temperature below which discharging power from the HV battery is permitted but charging the HV battery is not permitted. In one embodiment, threshold temperature 235 is −5 degrees Celsius. In other embodiments, a higher or lower threshold temperature 235 can be used. System data 240 includes a variety of persistent and temporary types of data used by cold-startup control system 100, such as system parameters, the results of intermediate calculations, etc.

Temperature detection module 220 generally includes machine-readable instructions that, when executed by the one or more processors 205, cause the one or more processors 205 to detect that a fuel cell 115 and a HV battery 120 are at a temperature that falls below a predetermined threshold temperature 235 below which discharging power from the HV battery 120 is permitted and charging the HV battery 120 is not permitted. Temperature detection module 220 measures and monitors the temperature of the fuel cell 115 and the HV battery 120 using one or more temperature sensors 215.

Cold-startup control module 225 generally includes machine-readable instructions that, when executed by the one or more processors 205, cause the one or more processors 205 to activate a battery heater 130 and power the battery heater 130 using the HV battery 120. Cold-startup control module 225 also includes machine-readable instructions that, when executed by the one or more processors 205, cause the one or more processors 205 to start up the fuel cell 115 by drawing additional power from the HV battery 120. This is the step during which the fuel cell 115 is effectively “jump started” from the HV battery 120. Cold-startup control module 225 also includes machine-readable instructions that, when executed by the one or more processors 205, cause the one or more processors 205 to consume, in the battery heater 130, power generated by the fuel cell 115 during startup until the fuel cell 115 is fully started up to avoid charging the HV battery while charging the HV battery is not permitted. That is, cold-startup control module 225 directs the power generated by the fuel cell 115 during startup to the battery heater 130 instead of to the HV battery 120.

It should be noted that, in some embodiments, cold-startup control module 225 can command the fuel cell system 110 during cold startup to generate a particular amount of power, and cold-startup control module 225 can command battery heater 130 to consume that same amount of power. For example, cold-startup control module 225 might command the fuel cell system 110 to generate 5 kW and command the battery heater 130 to consume 5 kW.

Though a secondary benefit of the embodiments described herein, during startup of the fuel cell 115, the battery heater 130 warms the HV battery 120. In some embodiments, once the fuel cell 115 has fully started up, the fuel cell 115 powers the battery heater 130 to continue warming up the HV battery 120.

FIG. 3 is a flowchart of a method 300 of controlling cold startup of a fuel cell 115, in accordance with an illustrative embodiment of the invention. Method 300 will be discussed from the perspective of cold-startup control system 100 in FIG. 2. While method 300 is discussed in combination with cold-startup control system 100, it should be appreciated that method 300 is not limited to being implemented within cold-startup control system 100, but cold-startup control system 100 is instead one example of a system that may implement method 300.

At block 310, temperature detection module 220 detects that a fuel cell 115 and a HV battery 120 are at a temperature that falls below a predetermined threshold temperature 235 below which discharging power from the HV battery 120 is permitted and charging the HV battery 120 is not permitted. As discussed above, temperature detection module 220 measures and monitors the temperature of the fuel cell 115 and the HV battery 120 using one or more temperature sensors 215. In one embodiment, threshold temperature 235 is-5 degrees Celsius. In other embodiments, a higher or lower threshold temperature 235 can be used.

At block 320, cold-startup control module 225 activates a battery heater 130 and powers the battery heater 130 using the HV battery 120. As discussed above, in some embodiments, battery heater 130 is a high-voltage electric heater. In other embodiments, battery heater 130 is a low-voltage electric heater for which a DC-to-DC converter converts the high voltage of the fuel cell 115 to the lower voltage required by the battery heater 130, permitting the battery heater 130 to consume power from the fuel cell 115 during cold startup.

At block 330, cold-startup control module 225 starts up the fuel cell 115 by drawing additional power from the HV battery 120. As discussed above, this is the step during which the fuel cell 115 is effectively “jump started” from the HV battery 120.

At block 340, cold-startup control module 225 consumes, in the battery heater 130, power generated by the fuel cell 115 during startup until the fuel cell 115 is fully started up to avoid charging the HV battery while charging the HV battery is not permitted. That is, cold-startup control module 225 directs the power generated by the fuel cell 115 during startup to the battery heater 130 instead of to the HV battery 120.

As discussed above, method 300 shortens the time required to start up a fuel cell 115 under low-temperature conditions (i.e., when charging the HV battery 120 using the initial power generated by the fuel cell 115 during startup is not permitted).

As discussed above, in some embodiments, cold-startup control module 225 can command the fuel cell system 110 during cold startup to generate a particular amount of power, and cold-startup control module 225 can command battery heater 130 to consume that same amount of power. For example, cold-startup control module 225 might command the fuel cell system 110 to generate 5 kW and command the battery heater 130 to consume 5 kW.

As also discussed above, during startup of the fuel cell 115, the battery heater 130 warms the HV battery 120, though that is a secondary benefit of the techniques disclosed herein. In some embodiments, once the fuel cell 115 has fully started up, the fuel cell 115 powers the battery heater 130 to continue warming up the HV battery 120.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-3, but the embodiments are not limited to the illustrated structure or application.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

Aspects herein can be embodied in other forms without departing from the spirit or essential attributes thereof. Accordingly, reference should be made to the following claims rather than to the foregoing specification, as indicating the scope hereof.

What is claimed is:

1. A system for controlling cold startup of a fuel cell, the system comprising:
a processor; and
a memory storing machine-readable instructions that, when executed by the processor, cause the processor to:
detect that the fuel cell and a high-voltage battery are at a temperature below a predetermined threshold temperature below which discharging power from the high-voltage battery is permitted and charging the high-voltage battery is not permitted;
activate a battery heater and power the battery heater using the high-voltage battery;
start up the fuel cell by drawing additional power from the high-voltage battery; and
consume, in the battery heater, power generated by the fuel cell during startup until the fuel cell is fully started up to avoid charging the high-voltage battery while charging the high-voltage battery is not permitted.

2. The system of claim 1, wherein the fuel cell is a hydrogen-powered fuel cell.

3. The system of claim 1, wherein, during startup of the fuel cell, the battery heater warms the high-voltage battery.

4. The system of claim 3, wherein the machine-readable instructions include further instructions that, when executed by the processor, cause the processor to power the battery heater using the fuel cell after the fuel cell has fully started up to continue warming up the high-voltage battery.

5. The system of claim 1, wherein the fuel cell powers a vehicle.

6. The system of claim 1, wherein the fuel cell powers a stationary electrical generator.

7. The system of claim 1, wherein the predetermined threshold temperature is-5 degrees Celsius.

8. A non-transitory computer-readable medium for controlling cold startup of a fuel cell and storing instructions that, when executed by a processor, cause the processor to:
detect that the fuel cell and a high-voltage battery are at a temperature below a predetermined threshold temperature below which discharging power from the high-voltage battery is permitted and charging the high-voltage battery is not permitted;
activate a battery heater and power the battery heater using the high-voltage battery;
start up the fuel cell by drawing additional power from the high-voltage battery; and
consume, in the battery heater, power generated by the fuel cell during startup until the fuel cell is fully started up to avoid charging the high-voltage battery while charging the high-voltage battery is not permitted.

9. The non-transitory computer-readable medium of claim 8, wherein the fuel cell is a hydrogen-powered fuel cell.

10. The non-transitory computer-readable medium of claim 8, wherein, during startup of the fuel cell, the battery heater warms the high-voltage battery.

11. The non-transitory computer-readable medium of claim 10, wherein the instructions include further instructions that, when executed by the processor, cause the processor to power the battery heater using the fuel cell after the fuel cell has fully started up to continue warming up the high-voltage battery.

12. The non-transitory computer-readable medium of claim 8, wherein the fuel cell powers a vehicle.

13. The non-transitory computer-readable medium of claim 8, wherein the fuel cell powers a stationary electrical generator.

14. A method, comprising:
detecting that a fuel cell and a high-voltage battery are at a temperature below a predetermined threshold temperature below which discharging power from the high-voltage battery is permitted and charging the high-voltage battery is not permitted;
activating a battery heater and powering the battery heater using the high-voltage battery;
starting up the fuel cell by drawing additional power from the high-voltage battery; and
consuming, in the battery heater, power generated by the fuel cell during startup until the fuel cell is fully started up to avoid charging the high-voltage battery while charging the high-voltage battery is not permitted.

15. The method of claim 14, wherein the fuel cell is a hydrogen-powered fuel cell.

16. The method of claim 14, wherein, during startup of the fuel cell, the battery heater warms the high-voltage battery.

17. The method of claim 16, further comprising powering the battery heater using the fuel cell after the fuel cell has fully started up to continue warming up the high-voltage battery.

18. The method of claim 14, wherein the fuel cell powers a vehicle.

19. The method of claim 14, wherein the fuel cell powers a stationary electrical generator.

20. The method of claim 14, wherein the predetermined threshold temperature is −5 degrees Celsius.
